(19) United States
(12) Patent Application Publication
(10) Pub. No.: US 2018/0031905 A1
(43) Pub. Date: Feb. 1, 2018

(54) COLOR FILTER SUBSTRATE, METHOD FOR MANUFACTURING COLOR FILTER SUBSTRATE, AND LIQUID CRYSTAL DISPLAY PANEL

(71) Applicant: Shenzhen China Star Optoelectronics Technology Co., Ltd., Shenzhen, Guangdong (CN)

(72) Inventors: Zhenxia CHEN, Shenzhen, Guangdong (CN); Xiaolong MA, Shenzhen, Guangdong (CN); Yung Jui LEE, Shenzhen, Guangdong (CN)

(73) Assignee: Shenzhen China Star Optoelectronics Technology Co., Ltd., Shenzhen, Guangdong (CN)

(21) Appl. No.: 14/907,949

(22) PCT Filed: Dec. 21, 2015
(86) PCT No.: PCT/CN2015/097994

§ 371 Date: Oct. 12, 2017

(30) Foreign Application Priority Data
Sep. 28, 2015 (CN) 201510625950.8

(51) Int. Cl. G02F 1/1335

(52) U.S. Cl. CPC G02F 1/133512; G02F 1/133514; G02F 1/133516; G02F 2202/22

(57) ABSTRACT

A color filter substrate, a method for manufacturing a color filter substrate, and a liquid crystal display panel are disclosed. The color filter substrate includes a baseplate, a black matrix layer, and a metal grid layer. The grid line of the metal grid layer is arranged corresponding to a frame of the black matrix layer, and a projection of the grid line of the metal grid layer on the baseplate falls inside a projection of the frame of the black matrix layer on the baseplate.

### CROSS REFERENCE TO RELATED APPLICATIONS

The present application claims the priority of Chinese patent application CN201510625950.8, entitled “Color Filter Substrate, Method for Manufacturing Color Filter Substrate, and Liquid Crystal Display Panel” and filed on Sep. 28, 2015, the entirety of which is incorporated herein by reference.

### FIELD OF THE INVENTION

The present disclosure relates to the technical field of liquid crystal display device, and particularly to a color filter substrate, a method for manufacturing color filter substrate, and a liquid crystal display panel.

### BACKGROUND OF THE INVENTION

With continuous development of liquid crystal display technology in recent years, there are many display technologies which can provide a wide viewing-angle display effect, such as In-Plate Swiching (IPS) technology and Fringe Field Switching (FFS) technology. According to the FFS technology and the IPS technology, not only the wide viewing-angle can be realized, but also other desirable characteristics of a display device can be realized, such as a high light transmittance, a high picture contrast, a high brightness, and a low color shift.

The FFS technology and the IPS technology are both realized through a horizontal electric field control mode. FIG. 1 schematically shows a structure of a liquid crystal display panel of an IPS mode in the prior art. The liquid crystal display panel comprises a color filter substrate 110 and an array substrate 120 that are arranged facing each other, and a liquid crystal layer 130 that is arranged between the color filter substrate 110 and the array substrate 120. A black matrix 113 and a color filter layer 115 are arranged on an inner surface of the color filter substrate, and in general, a protection layer 117 is arranged on the black matrix and the color filter layer. A common electrode 123 and a pixel electrode 125 are formed on an inner surface of the array substrate 120, so that liquid crystal molecules in the liquid crystal layer can deflect under control of the horizontal electric field.

During manufacturing procedure or using procedure of a liquid crystal display device, electrostatic charges would accumulate on the color filter substrate. When the electrostatic charges accumulate thereon to a certain extent, an electrostatic field can be formed. The electrostatic field would bring about interference on the liquid crystal molecules in the liquid crystal layer, and thus an abnormal image would be displayed on the display device.

In order to prevent the influence of electrostatic charge on the liquid crystal layer, a transparent conductive Indium tin oxide (ITO) layer 119 is generally formed on an upper surface of the color filter substrate 110 through vacuum sputtering technology. Moreover, a thickness of the ITO layer should be increased so as to reduce a surface resistance thereof and obtain a better conductive effect. However, if the thickness of the ITO layer is increased, a light transmittance of the ITO layer would be reduced apparently. As shown in FIG. 2, when the thickness of the ITO layer is 200 Å, the surface resistance thereof is 2000Ω, and the transmittance of light with a wavelength of 400 nm is 98%; when the thickness of the ITO layer is increased to 400 Å, the surface resistance thereof is reduced to 500Ω, but the transmittance of light with a wavelength of 400 nm decreases to 80%. As a result, the overall brightness of the liquid crystal display panel would be reduced to a large extent.

Therefore, a color filter substrate on which an electrostatic charge conduction layer with a low surface resistance and a high light transmittance is formed is needed.

### SUMMARY OF THE INVENTION

The present disclosure aims to solve the technical problem that when a surface resistance of an electrostatic charge conduction layer of a color filter substrate decreases, a light transmittance thereof is excessively reduced in the prior art.

The present disclosure provides a color filter substrate, which comprises:

a baseplate;

a black matrix layer, which comprises a frame that is formed on a first surface of the baseplate; and

a metal grid layer, which comprises a grid line that is formed on a second surface of the baseplate opposite to the first surface thereof, wherein the grid line of the metal grid layer is arranged corresponding to the frame of the black matrix layer, and a projection of the grid line of the metal grid layer on the baseplate falls inside a projection of the frame of the black matrix layer on the baseplate.

According to one embodiment, the grid line of the metal grid layer forms a plurality of grid units, which are arranged corresponding to a plurality of rectangular units of the black matrix layer one-to-one.

According to one embodiment, the grid line of the metal grid layer forms a plurality of grid units, and each grid unit is arranged corresponding to at least one rectangular unit of the black matrix layer.

According to one embodiment, a width of the grid line of the metal grid layer is less than a width of the frame of the black matrix layer.

The present disclosure provides a method for manufacturing a color filter substrate, which comprises following steps:

providing a baseplate;

forming a frame of a black matrix layer on a first surface of the baseplate; and

forming a grid line of a metal grid layer on a second surface of the baseplate opposite to the first surface thereof, such that the grid line of the metal grid layer is arranged corresponding to the frame of the black matrix layer, and a projection of the grid line of the metal grid layer on the baseplate falls inside a projection of the frame of the black matrix layer on the baseplate.

According to one embodiment, the step of forming a grid line of a metal grid layer on a second surface of the baseplate opposite to the first surface thereof comprises following sub steps:

coating the second surface of the baseplate with a photoresist;

exposing and developing the photoresist with a photomask so as to form a gap region and a residual region;

depositing a metal film on the gap region and the residual region; and

removing the photoresist on the residual region and the metal film that is deposited on the residual region, and reserving the metal film that is deposited on the gap region through a developing technology so as to obtain the metal grid layer.

According to one embodiment, the metal grid layer comprises a plurality of grid units, which are arranged corresponding to a plurality of rectangular units of the black matrix layer one-to-one.

According to one embodiment, a width of the gap region is less than a width of the frame of the black matrix layer.

The present disclosure further provides a liquid crystal display panel, which comprises:

the aforesaid color filter substrate; and

an array substrate, which is arranged facing the color filter substrate, wherein the metal grid layer is connected with a ground end of the array substrate.

In the color filter substrate according to the present disclosure, the metal grid layer serves as an electrostatic charge conduction layer, and thus the electrostatic charge conduction layer has a high light transmittance and a low surface resistance. Moreover, the metal grid layer has a good bendability and thus can be used in a curved substrate. Furthermore, in traditional Indium tin oxide (ITO) layer, indium (In) is a rare metal element, and thus there is a risk of raw material shortage. According to the present disclosure, the metal grid layer can be made of common metal materials, such as tungsten (W), titanium (Ti), molybdenum (Mo), or copper (Cu), and thus has a good practical applicability.

Other features and advantages of the present disclosure will be further explained in the following description, and partially become self-evident therefrom, or be understood through the embodiments of the present disclosure. The objectives and advantages of the present disclosure will be achieved through the structure specifically pointed out in the description, claims, and the accompanying drawings.

### BRIEF DESCRIPTION OF THE DRAWINGS

The accompanying drawings provide further understandings of the present disclosure and constitute one part of the description. The drawings are used for interpreting the present disclosure together with the embodiments, not for limiting the present disclosure. In the drawings:

FIG. 1 schematically shows a structure of a liquid crystal display panel of an IPS mode in the prior art;

FIG. 2 schematically shows a relationship among a thickness of an ITO layer, a surface resistance, and a light transmittance thereof in the prior art;

FIG. 3 schematically shows a sectional view of a color filter substrate according to embodiment 1 of the present disclosure;

FIG. 4 schematically shows a structure of a black matrix and a metal grid according to embodiment 1 of the present disclosure;

FIG. 5 schematically shows another structure of a black matrix and a metal grid according to embodiment 1 of the present disclosure;

FIG. 6 schematically shows a third structure of a black matrix and a metal grid according to embodiment 1 of the present disclosure;

FIG. 7 is a flow chart of a method for manufacturing a color filter substrate according to embodiment 2 of the present disclosure;

FIG. 8a schematically shows a structure of a color filter substrate after a photoresist is coated thereon according to embodiment 2 of the present disclosure;

FIG. 8b schematically shows a structure of the color filter substrate after exposing and developing procedures according to embodiment 2 of the present disclosure;

FIG. 8c schematically shows a structure of the color filter substrate after a metal film is deposited thereon according to embodiment 2 of the present disclosure;

FIG. 8d schematically shows a structure of the color filter substrate after a second developing procedure according to embodiment 2 of the present disclosure; and

FIG. 9 schematically shows a structure of a liquid crystal display panel according to embodiment 3 of the present disclosure.

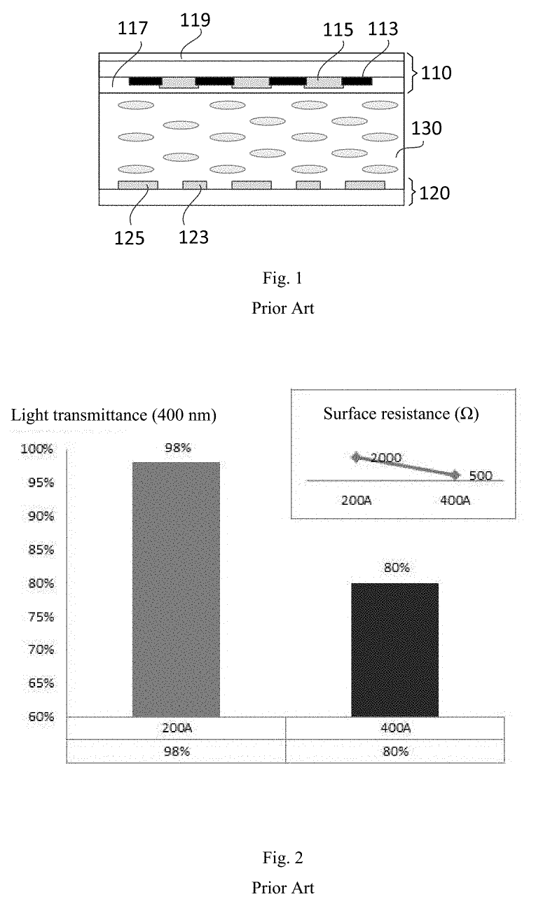

### DETAILED DESCRIPTION OF THE EMBODIMENTS

The present disclosure will be illustrated in detail hereinafter in combination with the accompanying drawings to enable the purpose, technical solutions, and advantages of the present disclosure more clear.

The embodiment of the present disclosure will be explained in detail hereinafter with reference to the accompanying drawings. It can be understood that, the preferred embodiments described herein are only used for explaining and illustrating, rather than restricting, the present disclosure. The technical features in the embodiments can be combined together in any manner, as long as there is no conflict.

### Embodiment 1

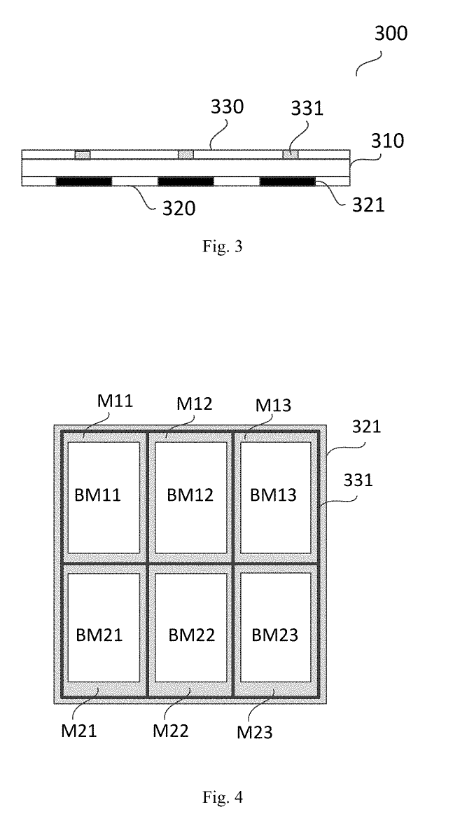

The present embodiment provides a color filter substrate. As shown in FIG. 3, the color filter substrate 300 comprises a baseplate 310, and a black matrix layer 320 and a metal grid layer 330 that are arranged on two sides of the baseplate 310 respectively. Specifically, the black matrix layer 320 comprises a frame 321 that is formed on a first surface of the baseplate 310, and the metal grid layer 330 comprises a grid line 331 that is formed on a second surface of the baseplate opposite to the first surface thereof. Compared with traditional ITO layer, the metal grid layer 330 has a low impedance. When electrostatic charges accumulate on the color filter substrate 300, the electrostatic charges can be conducted by the metal grid layer 330.

FIG. 4 schematically shows a structure of a metal grid and a black matrix of the color filter substrate. As shown in FIG. 4, the black matrix layer comprises a plurality of rectangular units BM11 to BM23 formed by the frame 321, and the metal grid layer comprises a plurality of grid units M11 to M23 formed by the grid line 331.

Since the grid line 331 is a non-transparent metal line, the grid line 331 should be arranged overlapping with the frame 321 as much as possible so as to ensure a light transmittance of the color filter substrate. That is, the positions of the grid units M11 to M23 should be arranged in a reasonable manner so that a projection of the grid line of the metal grid layer on the baseplate falls inside a projection of the frame of the black matrix layer on the baseplate. In this manner, a light transmission region of the rectangular units BM11 to BM23 cannot be shaded by the grid line 331. According to the example as shown in FIG. 4, the grid units M11 to M23 are preferably arranged corresponding to the rectangular units BM11 to BM23 one-to-one.

However, if the grid line is arranged overlapping with the frame of the black matrix, moire fringe would be generated when light that is emitted by a backlight module of a liquid crystal display device passes through the metal grid layer and the black matrix layer. As a result, a quality of an image displayed on the display device would be reduced. In order to eliminate the moire fringe, a width of the grid line 331 is arranged less than a width of the frame 321 of the black matrix. In general, the width of the frame of the black matrix is larger than 5 and thus the width of the grid line 331 is preferably set in a range from 150 nm to 5 μm.

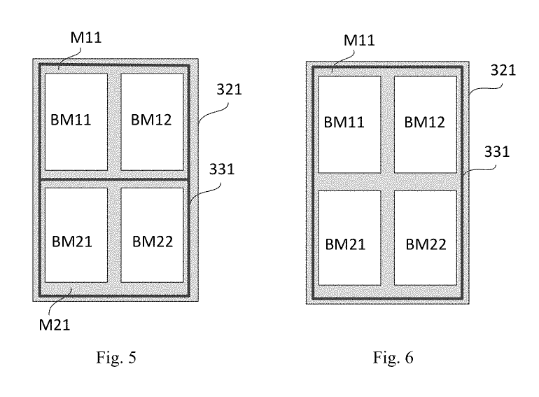

Alternatively, each grid unit can also be arranged corresponding to at least one rectangular unit of the black matrix layer. According to the example as shown in FIG. 5, the grid unit M11 is arranged corresponding to a rectangle that is constituted by the rectangular units BM11 and BM12. Similarly, according to the example as shown in FIG. 6, the grid unit M11 is arranged corresponding to a rectangle that is constituted by the rectangular units BM11, BM12, BM21, and BM22. In the metal grid layer as shown in FIGS. 5 and 6, part of grid line can be saved. Therefore, a manufacturing difficulty of the metal grid can be reduced, the metal raw material can be saved, and a manufacturing cost thereof can be reduced accordingly.

It can be understood that, the abovementioned shapes of the grid units are only examples, and are not used for restricting the present disclosure. The grid units with other shapes can be designed by those skilled in the art according to actual needs.

In a word, in the color filter substrate according to the present embodiment, the metal grid layer serves as an electrostatic charge conduction layer, and thus the electrostatic charge conduction layer has a high light transmittance and a low surface resistance. Moreover, the metal grid layer has a good bendability and thus can be used in a curved substrate. Furthermore, in traditional Indium tin oxide (ITO) layer, indium (In) is a rare metal element, and thus there is a risk of raw material shortage. According to the present embodiment, the metal grid layer can be made of common metal materials, such as tungsten (W), titanium (Ti), molybdenum (Mo), or copper (Cu), and thus has a good practical applicability.

### Embodiment 2

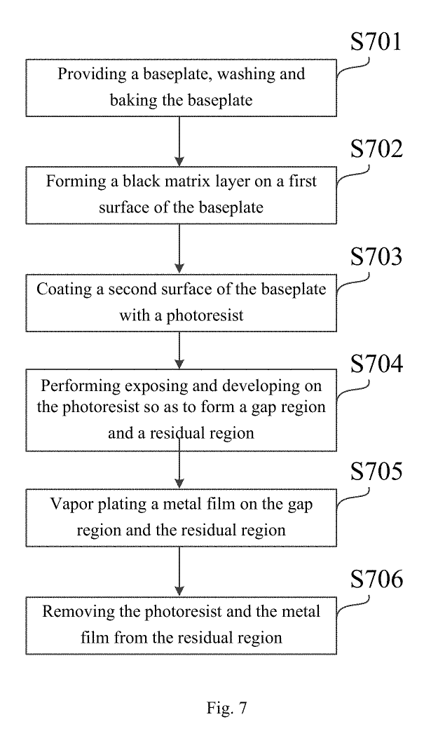

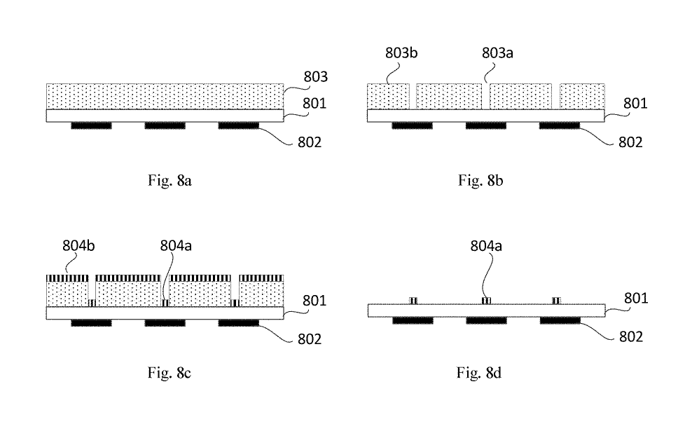

The present embodiment provides a method for manufacturing a color filter substrate. The method mainly comprises a step of forming a metal grid layer on a baseplate. The method will be illustrated in detail below with reference to FIGS. 7, and 8a to 8d.

In step S701, a baseplate is provided, and then the baseplate is washed and baked. In step S702, a frame 802 of a black matrix layer is formed on a first surface of the baseplate 801. As shown in FIG. 8a, in step S703, a second surface of the baseplate is coated with a photoresist 803. Then, the photoresist is dried in a low pressure so that the photoresist can be fully fixed. The photoresist 803 is preferably a positive photoresist. For example, Polymer film on array (PFA) that is prepared by Japan Synthetic Rubber Co (JSR) can be used. A coating accuracy of the photoresist should reach 150 nm, and a thickness thereof ranges from 1.5 μm to 5 μm.

Then, in step S704, the photoresist 803 is exposed and developed with a photomask, so that a gap region 803a and a residual region 803b as shown in FIG. 8b can be formed. The pattern of the photomask corresponds to the rectangular units of the black matrix.

Next, in step S705, a metal film is vapor plated on the gap region 803a and the residual region 803b through Physical Vapor Deposition (PVD) method. A thickness of the metal film ranges from 10 nm to 100 nm. Since there is a large height difference between a top of a metal film 804a on the gap region and a top of a metal film 804b on the residual region, after the deposition procedure, the metal film 804a on the gap region and the metal film 804b on the residual region are not connected together.

At last, in step S706, the photoresist and the metal film 804b on the residual region 803b are removed through a developing procedure, and the metal film 804a on the gap region is reserved, so that the grid line of the metal grid layer can be obtained, as shown in FIG. 8d. The metal film can be made of common metal materials, such as tungsten (W), titanium (Ti), molybdenum (Mo), or copper (Cu).

The grid line of the metal grid layer can be formed on the second surface of the baseplate through the aforesaid steps 5703 to 5706. It should be noted that, in step S704, the pattern of the photomask corresponding to the rectangular units of the black matrix means that, the gap region 803a that is formed by the photomask corresponds to the frame 321 of the black matrix, so that a projection of the gap region 803a on the baseplate falls inside a projection of the frame of the black matrix layer on the baseplate. The metal grid layer that is obtained in step S706 comprises a plurality of grid units, which are arranged corresponding to a plurality of rectangular units of the black matrix layer one-to-one (as shown in FIG. 4), or corresponding to at least one rectangular unit of the black matrix layer (as shown in FIG. 5 or FIG. 6). The metal grid layer has a high light transmittance and a low surface resistance. The width of the gap region 803a is less than the width of the frame of the black matrix layer. Preferably, the width of the gap region 803a is set in a range from 150 nm to 5 μm.

It can be seen that, according to the present embodiment, the method for manufacturing the color filter substrate is simple, and the expensive high temperature sputtering equipment which must be used during ITO layer deposition in the prior art is not used herein. Therefore, the method has a good practical applicability.

### Embodiment 3

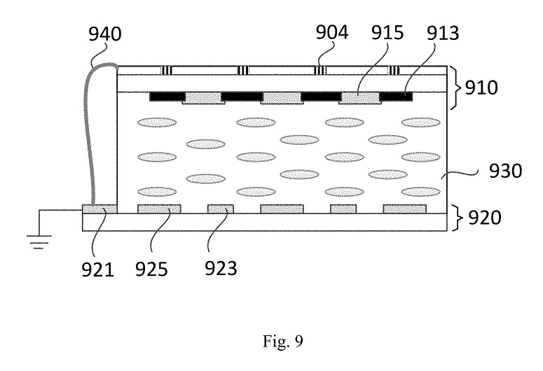

The present embodiment provides a liquid crystal display panel. Preferably, the liquid crystal display panel is driven in an FFS mode or an IPS mode. As shown in FIG. 9, the liquid crystal display panel comprises a color filter substrate 910 and an array substrate 920 that are arranged facing each other. A liquid crystal layer 930 is arranged between the color filter substrate 910 and the array substrate 920. The color filter substrate 910 is made by the aforesaid method.

Specifically, a black matrix layer 913 and a color filter layer 915 are arranged on an inner surface of the color filter substrate 910, and a metal grid layer 904 is arranged on an outer surface of the color filter substrate 910. The grid line of the metal grid layer 904 is arranged corresponding to a frame of the black matrix, and the specific arrangement method thereof is the same as that in embodiment 1. The details of which are no longer repeated here. Here, the “inner surface” of the color filter substrate 910 refers to a surface thereof facing the array substrate 920, and the “outer surface” of the color filter substrate 910 refers to a surface thereof far from the array substrate 920.

A common electrode 923 and a pixel electrode 925 are formed on an inner surface of the array substrate 920, so that liquid crystal molecules in the liquid crystal layer can deflect under control of a horizontal electric field. Here, the “inner surface” of the array substrate 920 refers to a surface thereof facing the color filter substrate 910.

The array substrate 920 is provided with a ground end 921, and the metal grid layer 904 is connected with the ground end 921 through a connector 940. When electrostatic charges accumulate on the color filter substrate 910, the electrostatic charges can be released by the metal grid layer 904 through the ground end 921. In this manner, it can be ensured that the liquid crystal molecules in the liquid crystal layer are not interfered by the electrostatic field.

Moreover, since the metal grid layer 904 has a high light transmittance, according to the present embodiment, the liquid crystal display panel can have a higher brightness and a better display effect.

The above embodiments are described only for better understanding, rather than restricting, the present disclosure. Any person skilled in the art can make amendments to the implementing forms or details without departing from the spirit and scope of the present disclosure. The protection scope of the present disclosure shall be determined by the scope as defined in the claims.

1. A color filter substrate, comprising:
a baseplate;
a black matrix layer, which comprises a frame that is formed on a first surface of the baseplate; and
a metal grid layer, which comprises a grid line that is formed on a second surface of the baseplate opposite to the first surface thereof, wherein the grid line of the metal grid layer is arranged corresponding to the frame of the black matrix layer, and a projection of the grid line of the metal grid layer on the baseplate falls inside a projection of the frame of the black matrix layer on the baseplate.

2. The substrate according to claim 1, wherein a width of the grid line of the metal grid layer is less than a width of the frame of the black matrix layer.

3. The substrate according to claim 1, wherein the grid line of the metal grid layer forms a plurality of grid units, which are arranged corresponding to a plurality of rectangular units of the black matrix layer one-to-one.

4. The substrate according to claim 3, wherein a width of the grid line of the metal grid layer is less than a width of the frame of the black matrix layer.

5. The substrate according to claim 1, wherein the grid line of the metal grid layer forms a plurality of grid units, and each grid unit is arranged corresponding to at least one rectangular unit of the black matrix layer.

6. The substrate according to claim 5, wherein a width of the grid line of the metal grid layer is less than a width of the frame of the black matrix layer.

7. A method for manufacturing a color filter substrate, comprising following steps:
providing a baseplate;
forming a frame of a black matrix layer on a first surface of the baseplate; and
forming a grid line of a metal grid layer on a second surface of the baseplate opposite to the first surface thereof, such that the grid line of the metal grid layer is arranged corresponding to the frame of the black matrix layer, and a projection of the grid line of the metal grid layer on the baseplate falls inside a projection of the frame of the black matrix layer on the baseplate.

8. The method according to claim 7, wherein the step of forming a grid line of a metal grid layer on a second surface of the baseplate opposite to the first surface thereof comprises following sub steps:
coating the second surface of the baseplate with a photoresist;
exposing and developing the photoresist with a photomask so as to form a gap region and a residual region;
depositing a metal film on the gap region and the residual region; and
removing the photoresist on the residual region and the metal film that is deposited on the residual region, and reserving the metal film that is deposited on the gap region through a developing technology so as to obtain the metal grid layer.

9. The method according to claim 8, wherein a width of the gap region is less than a width of the frame of the black matrix layer.

10. The method according to claim 8, wherein the metal grid layer comprises a plurality of grid units, which are arranged corresponding to a plurality of rectangular units of the black matrix layer one-to-one.

11. The method according to claim 10, wherein a width of the gap region is less than a width of the frame of the black matrix layer.

12. The method according to claim 8, wherein the metal grid layer comprises a plurality of grid units, and each grid unit is arranged corresponding to at least one rectangular unit of the black matrix layer.

13. The method according to claim 12, wherein a width of the gap region is less than a width of the frame of the black matrix layer.

14. A liquid crystal display panel, comprising:
a color filter substrate, which comprises:
a baseplate;
a black matrix layer, which comprises a frame that is formed on a first surface of the baseplate; and
a metal grid layer, which comprises a grid line that is formed on a second surface of the baseplate opposite to the first surface thereof, wherein the grid line of the metal grid layer is arranged corresponding to the frame of the black matrix layer, and a projection of the grid line of the metal grid layer on the baseplate falls inside a projection of the frame of the black matrix layer on the baseplate; and
an array substrate, which is arranged facing the color filter substrate, wherein the metal grid layer is connected with a ground end of the array substrate.

15. The liquid crystal display panel according to claim 14, wherein a width of the grid line of the metal grid layer is less than a width of the frame of the black matrix layer.

16. The liquid crystal display panel according to claim 14, wherein the grid line of the metal grid layer forms a plurality of grid units, which are arranged corresponding to a plurality of rectangular units of the black matrix layer one-to-one.

17. The liquid crystal display panel according to claim 16, wherein a width of the grid line of the metal grid layer is less than a width of the frame of the black matrix layer.

18. The liquid crystal display panel according to claim 14, wherein the grid line of the metal grid layer forms a plurality of grid units, and each grid unit is arranged corresponding to at least one rectangular unit of the black matrix layer.

19. The liquid crystal display panel according to claim 18, wherein a width of the grid line of the metal grid layer is less than a width of the frame of the black matrix layer.
